(19) United States
(12) Patent Application Publication
(10) Pub. No.: US 2014/0056023 A1
(43) Pub. Date: Feb. 27, 2014

(54) BROADBAND LIGHT SOURCE

(71) Applicant: Takemi Hasegawa, Yokohama-shi (JP)

(72) Inventor: Takemi Hasegawa, Yokohama-shi (JP)

(73) Assignee: Sumitomo Electric Industries, Ltd., Osaka-shi (JP)

(21) Appl. No.: 13/977,913

(22) PCT Filed: Sep. 21, 2012
(86) PCT No.: PCT/JP2012/074220

§ 371 Date: Jul. 1, 2013

(30) Foreign Application Priority Data
Sep. 27, 2011 (JP) 2011-211301

(51) Int. Cl. G02F 1/365

(52) U.S. Cl. CPC G02F 1/365
USPC 362/553

(57) ABSTRACT

A broadband light source that outputs broadband light with reduced peak power includes a pulsed light source, an optical fiber, a band-elimination filter, and a light echo unit. The optical fiber receives pulsed light output from the pulsed light source, expands the spectrum of the pulsed light by a nonlinear optical effect within the fiber to generate supercontinuum light, and outputs the supercontinuum light. The light echo unit has a plurality of optical paths between an input terminal and an output terminal thereof. At least one optical path in the plurality of optical paths serves as a loop optical path. The light echo unit receives, via the input terminal, the supercontinuum light output from the optical fiber and having traveled through the band-elimination filter, guides the supercontinuum light through the plurality of optical paths, and outputs the supercontinuum light guided by the plurality of optical paths from the output terminal.

### TECHNICAL FIELD

The present invention relates to broadband light sources that generate supercontinuum light in nonlinear optical media.

### BACKGROUND ART

When pulsed light with high peak power enters a nonlinear optical medium (such as an optical fiber), a nonlinear optical effect (such as self-phase modulation, four wave mixing, and Raman scattering) occurs, thus generating light having a new wavelength component. Consequently, the spectrum of the pulsed light is expanded so that supercontinuum light is generated. Due to having a wide spectrum band and being spatially in a single mode, supercontinuum light is expected to be utilized in various fields.

JP2009-092570A discusses a broadband light source that generates supercontinuum light. This broadband light source branches pulsed light output from a pulsed light source into a plurality of branched pulsed light beams. The branched pulsed light beams are given different strengths, are delayed differently from each other, and are made to enter a nonlinear optical medium. A two-input two-output optical coupler is used as converting means for converting the pulsed light output from the pulsed light source into a plurality of pulsed light beams. The pulsed light output from the pulsed light source is input to a first input terminal of the optical coupler, and the pulsed light output from a first output terminal is made to enter the nonlinear optical medium. Moreover, the pulsed light output from a second output terminal is input to a second input terminal so that a loop optical path is formed.

The broadband light source having the above-described configuration converts the pulses output from the pulsed light source into a plurality of echo pulses separated on a time axis, and makes the plurality of echo pulses enter the nonlinear optical medium. Since the echo pulses have different power, the way in which the spectrum expands in the nonlinear optical medium varies from echo pulse to echo pulse, resulting in different periods and phases of ripples in the spectrum. Therefore, the supercontinuum light output from the nonlinear optical medium can have a spectrum with reduced ripples.

### SUMMARY OF INVENTION

### Technical Problem

An object of the present invention is to provide a broadband light source that can output broadband light with reduced peak power.

### Solution to Problem

A broadband light source according to the present invention includes (1) a pulsed light source that repeatedly outputs pulsed light having a substantially fixed pulse width at a substantially fixed time interval; (2) a nonlinear optical medium that receives the pulsed light output from the pulsed light source, expands a spectrum of the pulsed light by a nonlinear optical effect within the nonlinear optical medium so as to generate supercontinuum light, and outputs the supercontinuum light; and (3) a light echo unit having a plurality of optical paths between an input terminal and an output terminal thereof. At least one optical path in the plurality of optical paths serves as a loop optical path. The light echo unit receives the supercontinuum light output from the nonlinear optical medium via the input terminal, guides the supercontinuum light through the plurality of optical paths, and outputs the supercontinuum light guided by the plurality of optical paths from the output terminal.

In the broadband light source according to the present invention, the light echo unit preferably includes an optical coupler having a first input terminal, a second input terminal, a first output terminal, and a second output terminal. The optical coupler preferably branches light input to the first input terminal or the second input terminal into two light beams and outputs the two light beams respectively from the first output terminal and the second output terminal. Moreover, the light echo unit is preferably provided with a loop optical path that optically connects the second input terminal and the second output terminal and imparts a propagation delay T. Assuming that the pulse width of the pulsed light output from the pulsed light source is defined as t and the time interval of the pulsed light output from the pulsed light source is defined as p, the relationship of Eq. (1):

t<T<p/10 (1)

preferably stands.

In the broadband light source according to the present invention, the optical coupler in the light echo unit preferably includes M optical couplers, M being an integer larger than or equal to 2. Moreover, the light echo unit is preferably provided with a loop optical path that optically connects the second input terminal and the second output terminal of an i-th optical coupler of the M optical couplers and has a propagation delay T[i]. Preferably, assuming that a and b are integers of 1 or 2, a pulse overlapping parameter d defined by Eq. (2):

d=min_{i<j}|aT[i]−bT[j]|/t i,j=1, . . . M (2)

is 0.75 or greater, and Eq. (3):

max(T[i])<p/10 i=1 . . . M (3)

stands.

Preferably, the broadband light source according to the present invention further includes a band-elimination filter that has a loss spectrum with a greater loss in a wavelength range outside a band having an full width of 10 nm or larger centered on a center wavelength of the pulsed light output from the pulsed light source. The band-elimination filter preferably receives the supercontinuum light output from the nonlinear optical medium, imparts a loss according to the loss spectrum to the supercontinuum light, and outputs the supercontinuum light.

### Advantageous Effects of Invention

The broadband light source according to the present invention can output broadband light with reduced peak power.

### BRIEF DESCRIPTION OF DRAWINGS

FIG. 1 is a schematic diagram of a broadband light source according to a first embodiment of the present invention.

FIG. 2 is a table used for determining a pulse overlapping parameter d in the broadband light source according to the first embodiment.

FIG. 3 is a schematic diagram of a broadband light source according to a second embodiment of the present invention.

FIG. 4 is a schematic diagram of a broadband light source according to a comparative example.

### DESCRIPTION OF EMBODIMENTS

Embodiments of the present invention will be described in detail below with reference to the appended drawings. In the drawings, the same components are given the identical reference numerals, and redundant descriptions will be omitted.

In the broadband light source discussed in JP2009-092570A, the peak power of echo pulses output from the optical coupler is high enough to cause a nonlinear optical effect in the nonlinear optical medium, and the peak power of the supercontinuum light output from the nonlinear optical medium is also high. As a result, for example, using this supercontinuum light as illuminating light for measurement may cause problems, such as deformation of the shape of the spectrum due to a nonlinear optical effect further occurring within an optical fiber that transmits the supercontinuum light to a measured object, degradation of a reflection reducing coating or burning of an end surface of the optical fiber in an optical system that transmits the supercontinuum light to the measured object, or damages to the measured object caused by heat generated instantaneously by absorption of the pulsed light or a strong optical electric field of the pulsed light. In contrast, a broadband light source according to the present invention can output broadband light with reduced peak power.

### First Embodiment

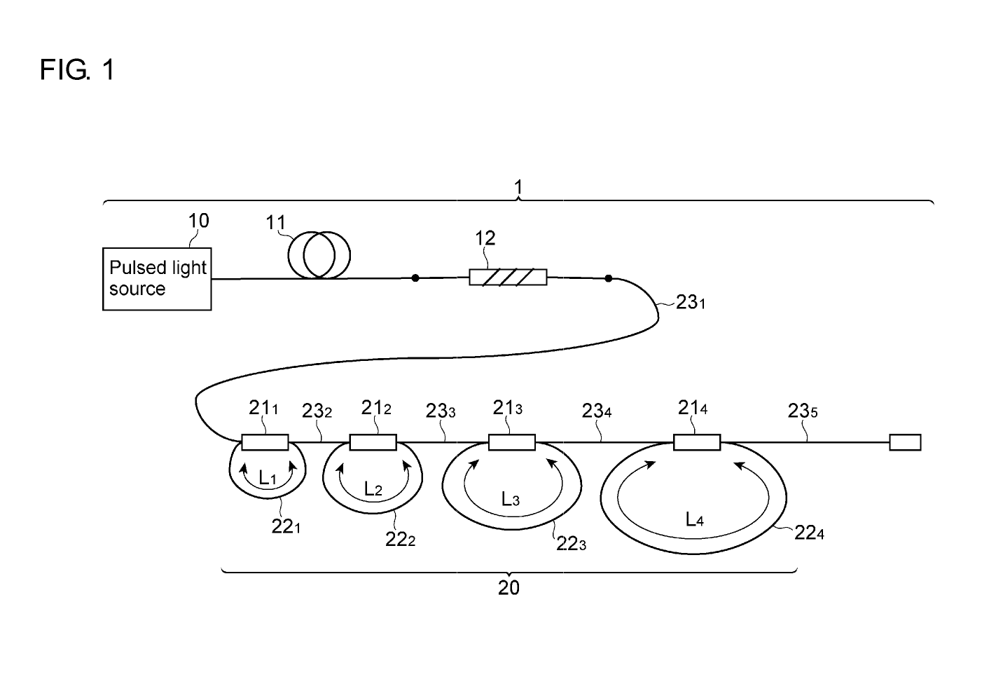

FIG. 1 is a schematic diagram of a broadband light source 1 according to a first embodiment of the present invention. The broadband light source 1 includes a pulsed light source 10, an optical fiber (nonlinear optical medium) 11, a band-elimination filter 12, and a light echo unit 20.

The pulsed light source 10 repeatedly outputs pulsed light having a substantially fixed pulse width at a substantially fixed time interval. In this case, the “substantially fixed” pulse width and the “substantially fixed” time interval imply that they are fixed except for that they may change due to unintentional factors, such as fluctuations in the power-supply voltage supplied to the light source, noise generated in the light source, and fluctuations in the ambient temperature of the light source, and the fluctuation range can normally be controlled within ±5%.

The pulsed light source 10 is preferably a pulsed laser light source that can output pulsed laser light with high peak power. Preferred examples of the pulsed light source 10 include a fiber laser light source that uses a rare-earth-doped optical fiber as an amplifying medium, a master-oscillator power-amplifier (MOPA) light source that amplifies seed light from a semiconductor laser or the like by means of a fiber amplifier that uses a rare-earth-doped optical fiber as an amplifying medium, and a titanium-sapphire laser light source.

In a fiber laser light source or a MOPA light source mentioned above, if the rare-earth element added to the rare-earth-doped optical fiber is an Er element, the wavelength of output pulsed light is 1550 nm, or if the rare-earth element added to the rare-earth-doped optical fiber is a Yb element, the wavelength of output pulsed light is 1060 nm. The wavelength of output pulsed light from a titanium-sapphire laser light source is 800 nm. The pulse width of output pulsed light from the pulsed light source 10 typically ranges between about 100 fs and 10 ns. The peak power of the output pulsed light from the pulsed light source 10 is typically 1 kW or higher.

The optical fiber 11 serving as a nonlinear optical medium receives the pulsed light output from the pulsed light source 10, expands the spectrum of the pulsed light by a nonlinear optical effect within the fiber so as to generate supercontinuum light, and outputs the supercontinuum light. The optical fiber 11 may be a special kind of optical fiber, such as a highly-nonlinear optical fiber or a photonic crystal fiber, or may be an ITU-T G.652 compliant single-mode optical fiber (i.e., a so-called standard single-mode optical fiber).

The pulsed light source 10 preferably generates pulsed light having a center wavelength of 1550 nm, a pulse width of 1 ns, and a peak power of 6 kW in repeating cycles of 100 kHz. Such a pulsed light source 10 can be achieved based on the MOPA method. The optical fiber 11 is preferably a standard single-mode optical fiber. This combination is advantageous in terms of lower costs since a special kind of optical fiber, such as a highly-nonlinear optical fiber or a photonic crystal fiber, is not used. In addition, the combination is advantageous in that a relatively high power density of about 1 mW/nm with a wavelength ranging between 1600 nm and 1800 nm can be obtained due to the occurrence of a nonlinear optical effect mainly including Raman scattering and modulation instability.

Because a material containing many C-H bonds, such as a lipid, has a distinctive absorption peak near a wavelength of 1700 nm, the broadband light source 1 that outputs supercontinuum light in such a spectrum band is suitable for detecting a material such as a lipid. Alternatively, the pulsed light source 10 and the optical fiber 11 may be achieved with various combinations other than the above.

The band-elimination filter 12 has a loss spectrum with a greater loss (for example, a loss ranging between 10 dB and 20 dB) in a wavelength range outside a band having a full width of 10 nm or larger centered on the center wavelength of the pulsed light output from the pulsed light source 10. The band-elimination filter 12 receives the supercontinuum light output from the optical fiber 11, imparts the loss according to the loss spectrum to the supercontinuum light, and outputs the supercontinuum light. Preferred examples of the band-elimination filter 12 include a slanted fiber grating having a Bragg diffraction grating formed slantwise at the core of an optical fiber, and a long-period fiber grating that utilizes optical coupling between a core mode and a cladding mode of an optical fiber.

Near the center wavelength of the pulsed light output from the pulsed light source 10, the supercontinuum light has a spectral peak resulting from the output pulsed light from the pulsed light source 10 and is thus difficult to be used for measurement since the spectral density is higher than that in other spectrum bands by 10 dB to 20 dB. However, with such a band-elimination filter 12 provided, non-uniformity in the spectral density of the supercontinuum light is reduced. Furthermore, since the total power of the supercontinuum light is reduced, deformation of the spectrum within a transmission fiber for transmitting the supercontinuum light or the occurrence of failures caused by the pulsed light, such as damages to optical components and measured objects, is reduced.

The light echo unit 20 has a plurality of optical paths between an input terminal and an output terminal thereof, and at least one optical path in the plurality of optical paths serves as a loop optical path. The light echo unit 20 receives, via the input terminal, the supercontinuum light output from the optical fiber 11 and having traveled through the band-elimination filter 12, guides the supercontinuum light through the plurality of optical paths, and outputs the supercontinuum light guided by the plurality of optical paths from the output terminal.

The light echo unit 20 includes four optical couplers 21₁, 21₂, 21₃, and 21₄. Each optical coupler 21ᵢ (i=1, 2, 3, or 4) has a first input terminal, a second input terminal, a first output terminal, and a second output terminal, and can branch light input to the first input terminal or the second input terminal into two light beams at a branching ratio of 50:50 and output the two light beams respectively from the first output terminal and the second output terminal. The second input terminal and the second output terminal of each optical coupler 21ᵢ are optically connected to each other by an optical fiber 22ᵢ so that a loop optical path with a loop length L[i] having a propagation delay T[i] is formed.

The band-elimination filter 12 and the first input terminal of the first-stage optical coupler 21₁ are connected to each other by an optical fiber 23₁. The first output terminal of the first-stage optical coupler 21₁ and the first input terminal of the second-stage optical coupler 21₂ are connected to each other by an optical fiber 23₂. The first output terminal of the second-stage optical coupler 21₂ and the first input terminal of the third-stage optical coupler 21₃ are connected to each other by an optical fiber 23₃. The first output terminal of the third-stage optical coupler 21₃ and the first input terminal of the fourth-stage optical coupler 21₄ are connected to each other by an optical fiber 23₄. The first output terminal of the fourth-stage optical coupler 21₄ is connected to an optical fiber 23₅.

Assuming that the pulse width of the pulsed light output from the pulsed light source 10 is defined as t and the time interval of the pulsed light output from the pulsed light source 10 is defined as p, each propagation delay T[i] preferably satisfies Eq. (4):

t<T[i]<p/10 i=1, . . . M (4)

### and Eq. (5):

max(T[i])<P/10 i=1, . . . , M (5)

In these expressions, the light echo unit 20 includes M optical couplers 21₁, . . . , 21_{M}, M being an integer larger than or equal to 2.

In the first embodiment, the loop lengths are as follows: L[1]=0.32 m, L[2]=0.48 m, L[3]=0.80 m, and L[4]=1.20 m. Since the optical fibers 22₁, 22₂, 22₃, and 22₄ are composed of silica-based glass and have a group refractive index of about 1.46, the group velocity of propagating light is 0.2 m/ns. As a result, the propagation delays are as follows: T[1]=1.6 ns, T[2]=2.4 ns, T[3]=4.0 ns, and T[4]=6.0 ns. The respective propagation delays are 1.6 times, 2.4 times, 4.0 times, and 6.0 times the pulse width of 1 ns of the output pulsed light from the pulsed light source 10.

As a result, relatively strong pulsed light output after looping once or twice around the loop optical path formed by each optical fiber 22ᵢ does not overlap other pulsed light on a time axis when the pulsed light is output to the optical fiber 23₅. Thus, the peak power of the supercontinuum light input to the input terminal of the light echo unit 20 is reduced to about 1/16 by the time the supercontinuum light is output from the output terminal of the light echo unit 20.

By using the supercontinuum light with reduced peak power for measurement in this manner, the occurrence of failures caused by the pulsed light, such as deformation of the spectrum within a transmission fiber or damages to optical components and measured objects, is reduced. The peak power can be further reduced by increasing the number of stages of the optical couplers.

More generally, assuming that the light echo unit 20 includes M optical couplers 21₁, . . . , 21_{M} and a and b are integers of 1 or 2, it is preferable that a pulse overlapping parameter d defined by Eq. (6):

d=min_{i<j}|aT[i]−bT[j]|/t i,j=1, . . . , M (6)

be 0.75 or greater. When the pulse overlapping parameter d is 0.75 or greater, the overlapping of looped pulsed light beams is suppressed to 25% or lower relative to the pulse width, whereby a favorable peak-power reduction effect is achieved.

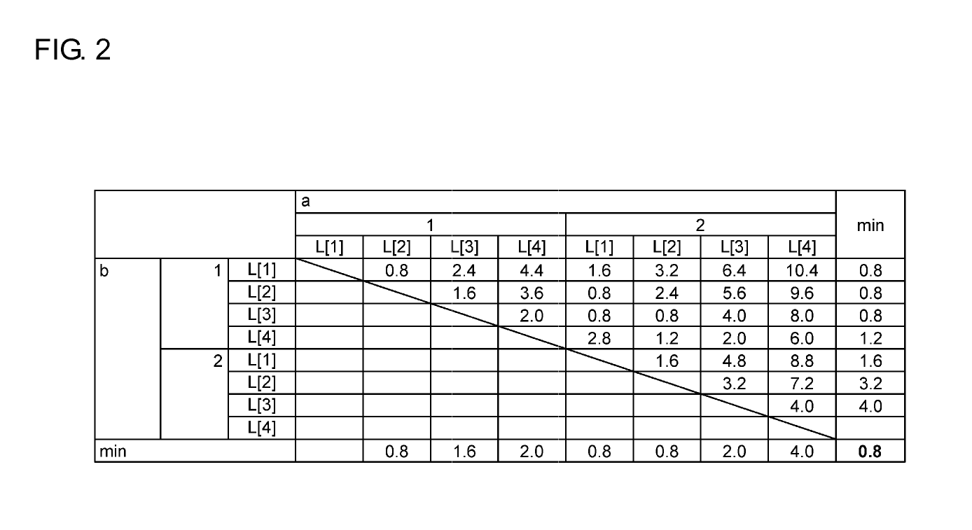

FIG. 2 is a table used for determining the pulse overlapping parameter d in the broadband light source 1 according to the first embodiment. FIG. 2 shows absolute values of aT[i] - bT[j] with respect to a and b values and i and j values, and also shows minimum values corresponding to rows or columns with respect to the absolute values. In the first embodiment having the loop length L[i] described above, the pulse overlapping parameter d is 0.8.

If the repeating cycle of the pulsed light output from the pulsed light source 10 is 100 kHz, the time interval p of the pulsed light is 0.01 ms. This time interval p is greater than or equal to 1600 times the propagation delay T[4]=6.0 ns of the longest loop optical path. Therefore, the overlapping of pulsed light beams in different repeating cycles is negligible. Because the branching ratio of each optical coupler 21ᵢ is 50:50, the peak power of pulsed light after looping around the loop optical path 10 times is (1/2)¹⁰≈1/1000, which is negligible. Therefore, it is desirable that the propagation delay of the longest loop optical path be smaller than or equal to 1/10 of the time interval p.

### Second Embodiment

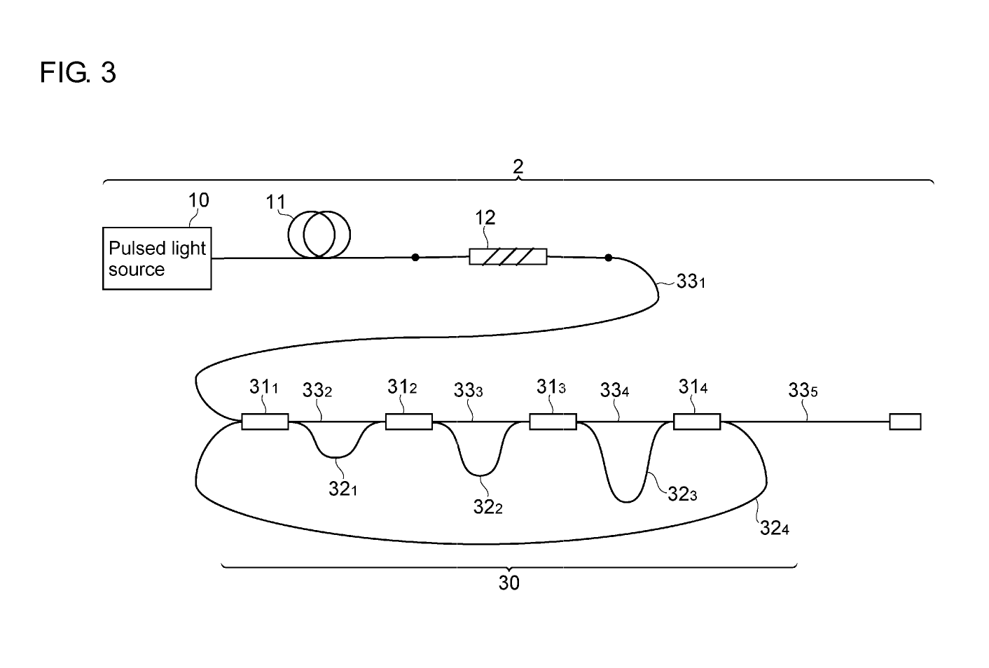

FIG. 3 is a schematic diagram of a broadband light source 2 according to a second embodiment of the present invention. The broadband light source 2 includes a pulsed light source 10, an optical fiber (nonlinear optical medium) 11, a band-elimination filter 12, and a light echo unit 30. The broadband light source 2 according to the second embodiment differs from the broadband light source 1 according to the first embodiment in being equipped with the light echo unit 30 in place of the light echo unit 20.

The light echo unit 30 has a plurality of optical paths between an input terminal and an output terminal thereof, and at least one optical path in the plurality of optical paths serves as a loop optical path. The light echo unit 30 receives, via the input terminal, the supercontinuum light output from the optical fiber 11 and having traveled through the band-elimination filter 13, guides the supercontinuum light through the plurality of optical paths, and outputs the supercontinuum light guided by the plurality of optical paths from the output terminal.

The light echo unit 30 includes four optical couplers 31₁, 31₂, 31₃, and 31₄. Each optical coupler 31ᵢ (i=1, 2, 3, or 4) has a first input terminal, a second input terminal, a first output terminal, and a second output terminal, and can branch light input to the first input terminal or the second input terminal into two light beams at a branching ratio of 50:50 and output the two light beams respectively from the first output terminal and the second output terminal. The second output terminal of the first-stage optical coupler 31₁ and the second input terminal of the second-stage optical coupler 31₂ are connected to each other by an optical fiber 32₁. The second output terminal of the second-stage optical coupler 31₂ and the second input terminal of the third-stage optical coupler 31₃ are connected to each other by an optical fiber 32₂. The second output terminal of the third-stage optical coupler 31₃ and the second input terminal of the fourth-stage optical coupler 31₄ are connected to each other by an optical fiber 32₃. The second output terminal of the fourth-stage optical coupler 31₄ and the second input terminal of the first-stage optical coupler 31₁ are connected to each other by an optical fiber 32₄. Thus, loop optical paths are formed.

The band-elimination filter 12 and the first input terminal of the first-stage optical coupler 31₁ are connected to each other by an optical fiber 33₁. The first output terminal of the first-stage optical coupler 31₁ and the first input terminal of the second-stage optical coupler 31₂ are connected to each other by an optical fiber 33₂. The first output terminal of the second-stage optical coupler 31₂ and the first input terminal of the third-stage optical coupler 31₃ are connected to each other by an optical fiber 33₃. The first output terminal of the third-stage optical coupler 31₃ and the first input terminal of the fourth-stage optical coupler 31₄ are connected to each other by an optical fiber 33₄. The first output terminal of the fourth-stage optical coupler 31₄ is connected to an optical fiber 33₅.

In the light echo unit 30 according to the second embodiment, the second output terminal of a certain optical coupler and the second input terminal of another optical coupler are connected to each other by an optical fiber so that a loop optical path is formed. In the second embodiment, the light echo unit 30 has the above-described configuration so that the degree of freedom with respect to differences in propagation delays among the plurality of optical paths is enhanced. For example, an optical fiber coupler has a wide transmissible band and is thus suitable for use as the optical coupler 21ᵢ in the first embodiment or the optical coupler 31₁ in the second embodiment. On the other hand, in the case where loop optical paths are formed by using optical fibers as in the first embodiment, the minimum loop length is normally limited to about 0.2 m due to an excess length necessary for a minimum bending radius or fusion splicing of the optical fibers. However, in the light echo unit 30 according to the second embodiment, the differences in propagation delays among the branched optical paths can be adjusted on the order of 0.01 m.

### Comparative Example

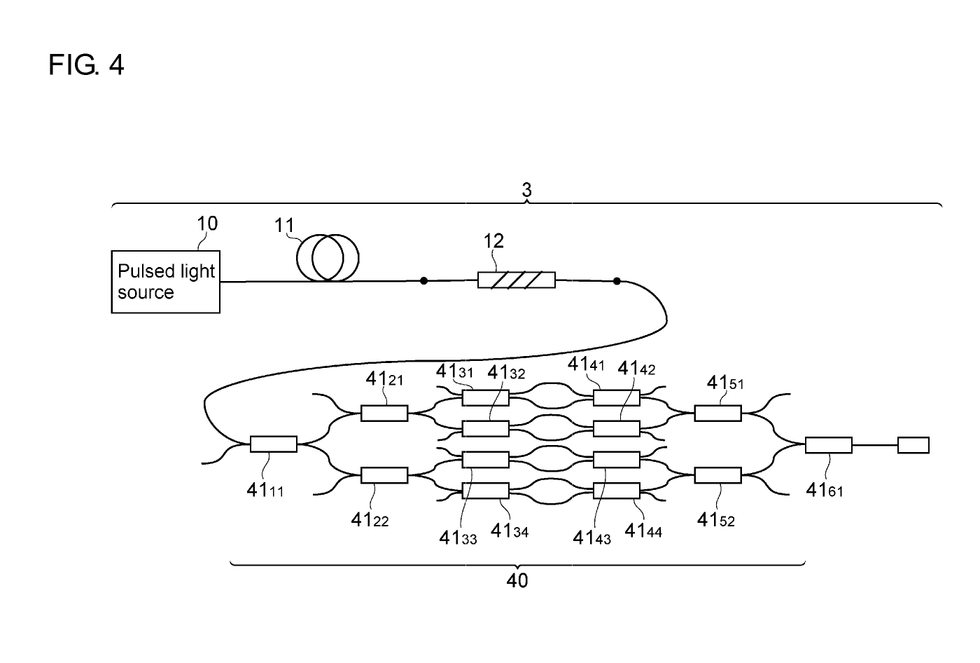

FIG. 4 is a schematic diagram of a broadband light source 3 according to a comparative example. The broadband light source 3 includes a pulsed light source 10, an optical fiber (nonlinear optical medium) 11, a band-elimination filter 12, and a light echo unit 40. The broadband light source 3 according to the comparative example differs from the broadband light source 1 according to the first embodiment in being equipped with the light echo unit 40 in place of the light echo unit 20.

The light echo unit 40 includes fourteen optical couplers 41₁₁, 41₂₁, 41₂₂, 41₃₁, 41₃₂, 41₃₃, 41₃₄, 41₄₁, 41₄₂, 41₄₃, 41₄₄, 41₅₁, 41₅₂, and 41₆₁. Light input to the light echo unit 40 from the band-elimination filter 12 is branched into eight light beams by the optical couplers 41₁₁, 41₂₁, 41₂₂, 4¹₃₁, 41₃₂, 41₃₃, and 41₃₄, and each of the eight branched light beams is input to an input terminal of one of the optical couplers 41₄₁, 41₄₂, 41₄₃, and 41₄₄.

However, the light output from one of two output terminals of each of the optical couplers 41₄₁, 41₄₂, 41₄₃, and 41₄₄ is input to one of the optical couplers 41₅₁ and 41₅₂, whereas the light output from the other output terminal is not utilized and becomes a loss. The light output from one of two output terminals of each of the optical couplers 41₅₁ and 41₅₂ is input to the optical coupler 41₆₁, whereas the light output from the other output terminal is not utilized and becomes a loss.

The light echo unit 40 having the above-described configuration has low power utilization efficiency and is not preferable due to not having any loop optical paths and having branched light beams that are not coupled to the output terminals. In contrast, the light echo unit 20 or 30 according the first or second embodiment loops the light beams branched by the optical couplers so as to couple all of the branched light beams to the output terminals, thereby achieving high power utilization efficiency.

### INDUSTRIAL APPLICABILITY

The broadband light source according to the present invention can be used as an illuminating light source for measurement.

1. A broadband light source comprising:
a pulsed light source that repeatedly outputs pulsed light having a substantially fixed pulse width t at a substantially fixed time interval p;
a nonlinear optical medium that receives the pulsed light output from the pulsed light source, expands a spectrum of the pulsed light by a nonlinear optical effect within the nonlinear optical medium so as to generate supercontinuum light, and outputs the supercontinuum light; and
a light echo unit having a plurality of optical paths between an input terminal and an output terminal thereof, wherein at least one optical path in the plurality of optical paths serves as a loop optical path, and wherein the light echo unit receives the supercontinuum light output from the nonlinear optical medium via the input terminal, guides the supercontinuum light through the plurality of optical paths, and outputs the supercontinuum light guided by the plurality of optical paths from the output terminal.

2. The broadband light source according to claim 1,
wherein the light echo unit includes
an optical coupler having a first input terminal, a second input terminal, a first output terminal, and a second output terminal, wherein the optical coupler branches light input to the first input terminal or the second input terminal into two light beams and outputs the two light beams respectively from the first output terminal and the second output terminal; and
a loop optical path that optically connects the second input terminal and the second output terminal and imparts a propagation delay T, wherein the delay T satisfies Eq. (1):
t<T<p/10 (1)

3. The broadband light source according to claim 2,
wherein the optical coupler in the light echo unit includes M optical couplers, M being an integer larger than or equal to 2, and wherein the light echo unit is provided with a loop optical path that optically connects the second input terminal and the second output terminal of an i-th optical coupler of the M optical couplers and has a propagation delay T[i], and
wherein, assuming that a and b are integers of 1 or 2, a pulse overlapping parameter d defined by Eq. (2):
d=min_{i<j}|aT[i]−bT[j]|/t i,j=1, . . . M (2)
is 0.75 or greater, and Eq. (3):
max(T[i])<p/10 i=1 . . . M (3)
stands.

4. The broadband light source according to claim 1, further comprising
a band-elimination filter that has a loss spectrum with a greater loss in a wavelength range outside a band having an full width of 10 nm or larger centered on a center wavelength of the pulsed light output from the pulsed light source, wherein the band-elimination filter receives the supercontinuum light output from the nonlinear optical medium, imparts a loss according to the loss spectrum to the supercontinuum light, and outputs the supercontinuum light.
